(19) United States
(12) Patent Application Publication
(10) Pub. No.: US 2025/0153251 A1
(43) Pub. Date: May 15, 2025

(54) A HOLDING DEVICE, AND ARRANGEMENT COMPRISING SAID HOLDING DEVICE

(71) Applicant: NINJAWERK GMBH, Vienna (AT)

(72) Inventors: Stefan MÜLLER, Berlin (DE); Florian HATWAGNER, Vienna (AT)

(21) Appl. No.: 18/832,742

(22) PCT Filed: Jan. 24, 2023
(86) PCT No.: PCT/AT2023/060015

§ 371 Date: Feb. 4, 2025

(30) Foreign Application Priority Data
Jan. 25, 2022 (AT) A 50029/2022

(51) Int. Cl. B23B 31/171

(52) U.S. Cl. CPC B23B 31/1612

(57) ABSTRACT

The invention related to a holding device (3), an arrangement and a method, the holding device (3) being designed to interlockingly receive and hold interchangeable ring (2) with holding cams (4) projecting radially outwards on the circumferential side, said holding device comprising a carrier ring (5) having a plurality of adjusting pins (7) which project in the axial direction and between which at least one insertion region (31) for receiving the interchangeable ring (2) is recessed, wherein a sleeve ring (6) positioned concentrically with respect to the carrier ring (5) is provided outside the carrier ring (5) and is rotatably and in particular interlockingly connected to the carrier ring (5), wherein the sleeve ring (6) has at least one radially inwardly protruding clamping jaw (8), wherein, in a first position of the sleeve ring (6) relative to the carrier ring (5), the clamping jaw (8) is positioned adjacent to the insertion ring (31) of the carrier ring (5) in the peripheral direction, and wherein in a second position of the sleeve ring (6) relative to the carrier ring (5), the clamping jaw (8) is positioned at least in part above the insertion region (31) of the carrier ring (5) in the peripheral direction.

The present application is a National Entry of PCT Application No. PCT/AT2023/060015, filed on Jan. 24, 2023, which claims priority to Austrian Application No. AT 50029/2022, filed on Jan. 25, 2022. The entire contents of such prior applications are incorporated by reference herein.

The invention relates to a holding device and an arrangement according to the preambles of the independent claims.

Various holding devices for attaching camera devices to vehicles, in particular aircrafts, are known from the state of the art. For example, holding devices are known in which the carrier part attached to the vehicle is bolted to the interchangeable part holding the camera device. However, the disadvantage of such holding devices is that at least two people are required to create or separate the bolted connection between the interchangeable part and the carrier part. For example, when creating the bolted connection, one person must hold the vehicle with the carrier part and the interchangeable part attached to it and the other person must bolt the two parts together. Thus the creation and separation of such a connection is very time-consuming.

Further, holding devices are known in which the carrier part and the interchangeable part can be connected or are connected to each other via a bayonet mount. Such conventional holding devices enable a quick and easy creation of a connection between the two parts. However, the disadvantage of such holding devices is that they cannot create a sufficiently secure connection between the two parts. Particularly when the vehicle or the camera device rotates sharply, the carrier part can twist in relation to the interchangeable part in such a way that the bayonet mount opens. With such holding devices, this may result on the one hand in damage to the camera device mounted on the interchangeable part. On the other hand, if the connection between the interchangeable part and the carrier part opens while in flight, for example, people and objects underneath the vehicle may also be damaged. Further, with regard to the control engineering in connection with the electromechanical stabilisation of the camera device, such holding devices do not allow a backlash-free connection, which means that oscillation and the generation of natural frequencies is possible, which may have a negative effect on the operation of the camera device.

The object of the invention is to overcome the disadvantages of the state of the art. In particular, it is the object of the invention to create a safe and easy-to-operate holding device. Among other things, the object of the invention is to create such a secure connection between the interchangeable ring and the carrier ring that no unintentional separation of the two parts can occur even during wild manoeuvres or movements of the vehicle. Further, it is another task of the invention that a connection between the interchangeable ring and the carrier ring can be made easily, quickly and reliably by a single person.

In particular, the object according to the invention is solved by the features of the independent claims.

The invention relates in particular to a holding device for positively receiving and holding an interchangeable ring with holding cams projecting in particular circumferentially and/or radially outwards.

Preferably, it is provided that the holding device comprises a carrier ring with several adjusting pins, in particular projecting on the front face and/or in the axial direction.

Preferably, it is provided that at least one insertion region, in particular for receiving the interchangeable ring, preferably for receiving the holding cams of the interchangeable ring, is recessed between the adjusting pins.

Preferably, it is provided that a sleeve ring positioned concentrically with respect to the carrier ring is provided outside the carrier ring and is rotatably and in particular positively connected to the carrier ring.

Preferably, it is provided that the sleeve ring has at least one clamping jaw projecting inwards, in particular on the front face and/or radially.

Preferably, it is provided that in a first position and/or first setting of the sleeve ring, in particular relative to the carrier ring, the clamping jaw is arranged, in particular in the circumferential direction, next to the insertion region of the carrier ring.

Preferably, it is provided that in a second position and/or second setting of the sleeve ring, in particular relative to the carrier ring, the clamping jaw, in particular in the circumferential direction, is arranged at least partially above the insertion region of the carrier ring.

Preferably, the holding cams are provided on the interchangeable ring.

Optionally, it is provided that the insertion region is free of adjusting pins.

The ring-like design of the carrier ring, the sleeve ring and the interchangeable ring allows a first contact device to be arranged within the holding device, in particular in its centre. In particular, the carrier ring, the sleeve ring and the interchangeable ring have a recess in their centre. Optionally, it is provided that a recess is provided within the holding device. The first contact device may be provided in the recess in the form of a circular insert. The first contact device may be designed with first electrical contacts, for example plug pins or sockets, for the electrical or electronic connection of a vehicle and a camera device.

Preferably, the first contact device may be configured to create an electrical or electronic connection with a second contact device arranged inside the interchangeable ring. The second contact device may be arranged in the centre of the interchangeable ring in the form of a circular insert and may have second electrical contacts, for example plug pins or sockets. This allows an electrical or electronic connection to be created between the first contact device and the second contact device when the interchangeable ring is inserted into the holding device.

The electrical contacts of the two contact devices may be formed in several, in particular four, orthogonally arranged rows, each with several, in particular four, plug pins and associated sockets.

The holding device may be designed to positively receive and may hold the interchangeable ring so that the interchangeable ring can be inserted into the holding device and removed from the holding device.

When the interchangeable ring is inserted into the holding device, its holding cams are preferably arranged in the at least one insertion region. The insertion region may be located between the adjusting pins on the carrier ring. Since the holding cams and the adjusting pins form a positive fit, rotation of the interchangeable ring relative to the holding device can be prevented.

To prevent the interchangeable ring from falling out, a sleeve ring with at least one inwardly projecting clamping jaw may be provided. The sleeve ring is preferably positively and rotatably connected to the carrier ring and may have two positions relative to the carrier ring.

In the first position of the sleeve ring, in the so-called insertion position, the clamping jaws may be arranged next to the insertion region. Preferably, in this position the clamping jaws project exclusively beyond the adjusting pins. Further, in this position, the insertion regions may be free of the clamping jaws, allowing the interchangeable ring to be inserted into the holding device and removed from the holding device without hindrance.

In the second position of the sleeve ring, in the so-called blocking position, the clamping jaws may be arranged above the insertion region. Preferably, the clamping jaws may be arranged rotated relative to the adjusting pins, thus causing the clamping jaws to project beyond the insertion region at least in sections. In this position, the interchangeable ring may be positively connected to the holding device, which prevents the interchangeable ring from being removed or falling out of the holding device without hindrance. Further, insertion of the interchangeable ring into the holding device may be blocked in this position.

The holding device allows a secure connection between the interchangeable ring and the holding device to be created quickly and easily. In particular, a separation of this connection can be substantially avoided even during fast manoeuvres of the vehicle, as the torque caused by the camera device arranged on the interchangeable ring substantially acts on the non-rotatable adjusting pins.

In particular, the carrier ring may have one attachment region or between two and ten, preferably four, attachment regions. Each attachment region may be formed by one to and including ten, preferably three, adjusting pins. Each attachment region may comprise one to and including ten, preferably three, adjusting pins.

The number of pins may be selected according to the diameter of the circumference on which they are arranged and/or depending on the material used.

The carrier ring may comprise one insertion region or between two and including ten, preferably four, insertion regions. The interchangeable ring may have one holding cam or between two and including ten, preferably four, holding cams. Preferably, it may be provided that the holding cams correspond to the insertion regions.

The sleeve ring may comprise one clamping jaw or between two and including ten, preferably four, clamping jaws. The clamping jaws may be formed from one clamping jaw part or several, in particular between two and including ten, preferably four, clamping jaw parts.

The carrier ring may be designed integrally. In particular, the parts of the carrier ring that cannot slide against each other may also be manufactured as one part.

Preferably, it is provided that the carrier ring comprises a base plate and a base part. In this case, the base plate and the base part may be frictionally connected to each other, in particular bolted together, and the adjusting pins may be arranged on the base part of the carrier ring.

Optionally, the first position and/or first setting of the sleeve ring may correspond to a first position and/or first setting of the holding device.

Optionally, the second position and/or second setting of the sleeve ring may correspond to a second position and/or second setting of the holding device.

Optionally, it is provided that the sleeve ring is designed and/or configured such that the sleeve ring can be brought from a first position and/or first setting into a second position and/or second setting.

Optionally, it is provided that the sleeve ring is formed with slots and that a clamping device is provided on the sleeve ring for compressing the sleeve ring, whereby in particular the sleeve ring may be frictionally connected to the carrier ring.

By tensioning the clamping device, the sleeve ring can be compressed and/or contracted. The sleeve ring and in particular the clamping jaws may be pressed towards the centre of the carrier ring by the compression. As a result, the sleeve ring can be positively and frictionally connected to the carrier ring, which prevents the sleeve ring from rotating relative to the carrier ring.

In particular with regard to the control engineering in connection with the electromechanical stabilisation of camera devices on vehicles, in particular aircrafts, the holding device may enable a backlash-free connection, which substantially excludes oscillation and the addition of natural frequencies.

In the context of the present invention, tensioning of the clamping device may be understood to mean any actuation, in particular closing, of the clamping device, by which the clamping device is in particular tensioned.

Optionally, it is provided that the carrier ring, in particular the outer circumference of the carrier ring, preferably the outer circumference of the base part, has a first projection with a first, in particular conical, sliding surface.

Optionally, it is provided that the sleeve ring, in particular the inner circumference of the sleeve ring, has a second projection with a second, in particular conical, sliding surface.

Optionally, it is provided that the first sliding surface and the second sliding surface are configured to interact.

Optionally, it is provided that the second sliding surface may be moved along the first sliding surface when the clamping device is tensioned, whereby in particular the holding cams of the interchangeable ring may be pressed against the clamping jaws of the sleeve ring.

The interaction of the first and second sliding surfaces allows the sleeve ring to be moved towards the carrier ring on the one hand and towards the centre of the carrier ring on the other when the clamping device is tensioned.

Optionally, it is provided that a first, in particular conical, sliding surface is provided on the outer circumference of the carrier ring and that a second, in particular conical, sliding surface is provided on the inner circumference of the sleeve ring. When the clamping device is tensioned, the second sliding surface may be movable along the first sliding surface, allowing the holding cams of the interchangeable ring to be pressed against the clamping jaws of the sleeve ring.

In other words, this allows a positive and frictional connection to be created, particularly in the radial and axial direction, between the clamping jaws and the holding cams. On the other hand, this also allows a positive and frictional connection to be created between the sleeve forming the sleeve ring and the holding cams.

As a result, the connection between the interchangeable ring and the holding device may be improved or increased quickly and easily. In particular, this can prevent any movement between the carrier ring and the interchangeable ring. In other words, tensioning the clamping device can create a substantially rigid connection between the interchangeable ring and the carrier ring.

Optionally, it is provided that the adjusting pins have at least one recess to form a weakened bending region.

Optionally, it is provided that the adjusting pins may be pressed in the direction of the centre of the carrier ring when the sleeve ring is tensioned by means of the clamping device.

Due to the weakened bending region formed by the recesses, the adjusting pins may be pressed towards the centre of the carrier ring when the clamping device is tensioned. In other words, the adjusting pins can be pressed into areas between the holding cams of the interchangeable ring, making it possible to create a positive and frictional connection.

Optionally, it is provided that at least one fixation device, preferably two fixation devices, for holding the sleeve ring in the first position is or are provided.

Preferably, the fixation device is designed to fix and/or hold the sleeve ring in its first position.

Preferably, it is provided that the holding device comprises at least one fixation device or between two and four, preferably at least two, fixation devices.

The use of at least two fixation devices may allow the sleeve ring to be brought into its second position only when the interchangeable ring rests, in particular flat, on the carrier ring. In other words, the sleeve ring can only be released when the interchangeable ring is fully inserted into the holding device.

In particular, it is provided that the at least two fixation devices are arranged opposite each other, in particular diametrically, on the holding device. In other words, the sleeve ring can only be released when the interchangeable ring is fully inserted. This can prevent premature release if the interchangeable ring is inserted at an angle.

Optionally, it is provided that the fixation device has and/or comprises a fixation pin with a fixation projection.

Optionally, it is provided that the fixation device is designed and/or configured such that the fixation device can be brought from a first position and/or first setting into a second position and/or second setting.

Optionally, it is provided that the fixation projection engages positively in a recess of the sleeve ring in a first position and/or first setting of the fixation device, whereby the sleeve ring is held and/or fixed in particular in its first position.

Optionally, it is provided that the fixation projection releases the sleeve ring in a second position and/or second setting of the fixation device, so that the sleeve ring is rotatable in particular relative to the carrier ring.

In the first position of the fixation device, the fixation projection may engage positively in a recess in the sleeve ring. This may prevent the sleeve ring from twisting in relation to the carrier ring. Preferably, it is provided that the sleeve ring may be fixed or held in its first position, in the so-called insertion position, by the fixation device.

In the second position of the fixation device, the fixation projection may be arranged at a distance from the recess of the sleeve ring. Thus, the sleeve ring may be twisted in relation to the carrier ring and brought into its second position, the so-called blocking position.

Optionally, it is provided that the fixation device, in particular the fixation pin, is arranged in a recess, in particular a bore, in the carrier ring.

Optionally, it is provided that a spring is provided which presses the fixation device into its first position.

Optionally, it is provided that the spring may be compressed by inserting the interchangeable ring into the holding device in order to bring the fixation device into its second position.

Preferably, a spring is arranged in the recess of the carrier ring, which engages frictionally in the fixation device, in particular in the fixation pin. Further, the spring may be set up to bring the fixation device into its first position, in particular to press it.

Preferably, it is provided that, when the fixation device is in its first position, the fixation pin projects at least partially beyond the carrier ring, in particular on the front face and/or in the axial direction. In other words, the fixation pin may project from the carrier ring when the fixation device is in its first position.

If the interchangeable ring is now inserted into the holding device, it may press on the protruding part of the fixation pin. This may also compress the spring and bring the fixation device to its second position, in which the sleeve ring may be rotated relative to the carrier ring.

Optionally, it is provided that a rotation device is provided, which is configured to bring the sleeve ring into its second position.

Preferably, the rotation device is configured to bring and/or bring the sleeve ring into its second position.

Optionally, it is provided that the rotation device comprises between one spring up to and including ten springs, preferably two springs, which is or are in engagement with the sleeve ring and the carrier ring.

Optionally, it is provided that the rotation device comprises one spring, two, three, four, five, six, seven, eight, nine or ten springs, which is or are in engagement with the sleeve ring and the carrier ring.

Optionally, it is provided that the rotation device is designed and/or configured such that the rotation device can be brought from a first position and/or first setting into a second position and/or second setting.

Optionally, it is provided that the rotation device has a first position in which the sleeve ring is in its first position and in which optionally the spring or springs generate a spring force F1.

Optionally, it is provided that the sleeve ring can be brought into its second position, and wherein the rotation device has a second position in which optionally the sleeve ring is in its second position and in which the spring or the springs generate(s) a spring force F2, wherein the spring force F2 is smaller than the spring force F1.

The spring or springs of the rotation device may or may not be arranged in an annular groove of the carrier ring.

Preferably, it is provided that a spring force F1 is generated by the spring or springs when the sleeve ring is in its first position, which pushes or pulls the sleeve ring into its second position. The spring or springs may be configured as compression or tension springs.

Preferably, it is provided that the spring or springs generate(s) a spring force F2 when the sleeve ring is in its second position, wherein the spring force F2 is smaller than the spring force F1. Optionally, it is provided that the spring or springs is or are partially released when the sleeve ring is in its second position.

Optionally, it is provided that the holding device has an insertion region or between two and including ten, preferably four, insertion regions.

Optionally, it is provided that the insertion regions are radially evenly distributed on the holding device.

Optionally, it is provided that the respective successively arranged insertion regions enclose an angle with one another in the range from 18° up to and including 90°, in particular 45°.

Optionally, it is provided that the clamping device comprises a clamping lever, a first clamping part, a second clamping part, three connection devices and/or an adjusting device, in particular an adjusting screw.

Optionally, it is provided that the first clamping part is connected to the sleeve ring via the first connection device.

Optionally, it is provided that the clamping lever is connected to the sleeve ring via the second connection device.

Optionally, it is provided that the second clamping part is connected to the clamping lever via the third connection device.

Optionally, it is provided that the first and second clamping parts are connected to each other via the adjusting device, whereby the distance between the two clamping parts can be changed and the clamping force of the clamping device can be adjusted by actuating, in particular rotating, the adjusting device.

Optionally, it is provided that the sleeve ring is designed to be self-locking, so that if parts of the clamping device, in particular the clamping lever and/or one of the clamping parts, are lost, it is not possible for the sleeve ring to extend beyond a predefined diameter. Optionally, it is provided that the sleeve ring is configured in a way that it can only be extended to a predefined diameter. This and the force that twists the sleeve ring may ensure that the interchangeable ring continues to be held on the holding device. In other words, in such a case, only the axial and radial positive pre-tensioning may no longer be guaranteed.

The clamping lever may have a further lever device, which is pretensioned by a further spring. This further lever device may have a hook which engages in a groove when the clamping lever is closed, optionally allowing the clamping device, in particular the clamping lever, to be brought into its holding position. The further lever device may be guided over a guide surface, in particular an inclined guide surface, and/or engage in the groove against the spring force of the further spring.

In the holding position of the clamping device, unintentional opening of the clamping device may be prevented.

The clamping lever may be released from its holding position by actuating the further lever device, optionally allowing the clamping device, in particular the clamping lever, to be brought into its release position. In the release position of the clamping device, the clamping device can be opened.

The clamping lever may have a blocking device, wherein the blocking device may engage in a recess of the carrier ring, in particular the base plate, when the sleeve ring is in its second position.

In other words, the clamping lever and the carrier ring may form a so-called tongue and groove system. The blocking device of the clamping lever may only engage in the recess of the carrier ring when the sleeve ring is in its second position. Further, the blocking device may be configured in a way that the clamping lever cannot reach its closed position in all other positions of the sleeve ring.

Optionally, it is provided that a securing device is provided on the sleeve ring.

Optionally, it is provided that the securing device is arranged to hold the clamping lever in its tensioned and/or closed setting, in particular its holding setting.

In particular, the invention relates to an arrangement comprising a holding device according to the invention and an interchangeable ring according to the invention.

Optionally, it is provided that the holding device is connected to a vehicle, in particular an aircraft, preferably a camera drone, and the interchangeable ring is connected to a camera device.

Optionally, it is provided that the holding device according to the invention is connected to a movable or stationary object.

Optionally, it is provided that the holding device according to the invention is connected to a movable or stationary apparatus.

Optionally, it is provided that the holding device according to the invention is connected to a handle, a tripod, a camera trolley, in particular a so-called dolly, a crane, a camera crane, a Steadicam and/or a slider.

Optionally, it is provided that the interchangeable ring according to the invention is connected to a camera device.

In particular, the invention relates to an interchangeable ring, wherein the interchangeable ring is configured for introduction and/or insertion into the holding device according to the invention.

Optionally, the interchangeable ring is designed such that it may be introduced and/or inserted into the holding device.

Optionally, it is provided that the interchangeable ring has holding cams projecting radially outwards on the circumference.

In particular, the invention relates to a method for attaching, introducing and/or inserting an interchangeable ring into the holding device, comprising the following steps:
Bringing the sleeve ring to its first position, in which the at least one clamping jaw is arranged next to the at least one insertion region,
inserting the interchangeable ring,
bringing the sleeve ring into its second position, in which the at least one clamping jaw is arranged at least in sections over the insertion region and thus over the holding cams of the interchangeable ring, so that the interchangeable ring is positively engaged with the holding device.

Optionally, it is provided that the method according to the invention comprises the following further step:
actuation and/or tensioning of the clamping device, whereby the sleeve ring is tensioned and both the clamping jaws are moved towards the carrier ring and in the direction of the centre of the carrier ring, and the adjusting pins are pressed towards the centre of the carrier ring, so that the holding cam(s) of the interchangeable ring is/are frictionally and positively engaged with the retaining device.
Optionally, bringing the clamping device, in particular the clamping lever, into its holding position, so that in particular the hook of the further lever device is engaged in a groove and/or the clamping lever is fixed to the securing device.

Optionally, it is provided that the method, in particular for removing the interchangeable ring from the holding device, comprises the following steps:
optionally, bringing the clamping device, in particular the clamping lever, from its holding position to its release position, so that in particular the hook of the further lever device is removed from the groove and/or moved and/or the clamping lever is released from the securing device,
opening and/or releasing the clamping device,
rotating the interchangeable ring so that the sleeve ring is brought into its first position, in which the at least one clamping jaw is or are arranged next to the at least one insertion region,
removing the interchangeable ring from the holding device.

Optionally, it is provided that the method steps of the method as described above follow one another.

Optionally, it is provided that the indicated semantic order does not necessarily correspond to the chronological order.

Further features according to the invention optionally emerge from the claims, the description of the exemplary embodiments, and the figures.

The invention is now further explained with reference to non-exclusive and/or non-limiting exemplary embodiments.

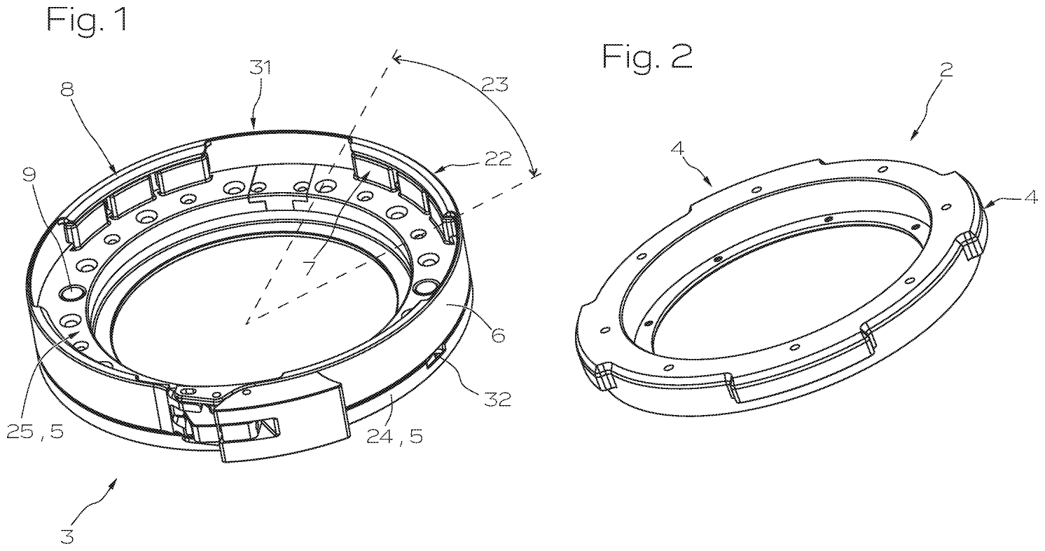

FIG. 1 shows a schematic graphical representation of a first embodiment of the holding device according to the invention,

FIG. 2 shows a schematic graphical representation of a first embodiment of the interchangeable ring according to the invention,

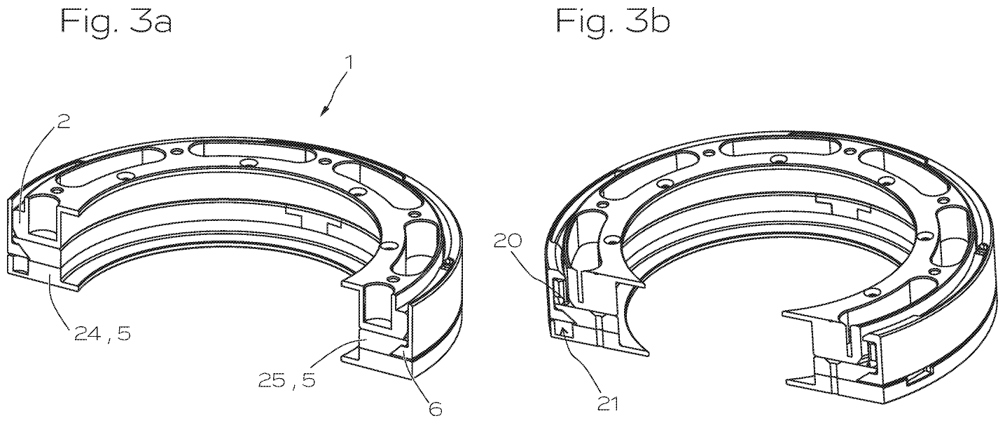

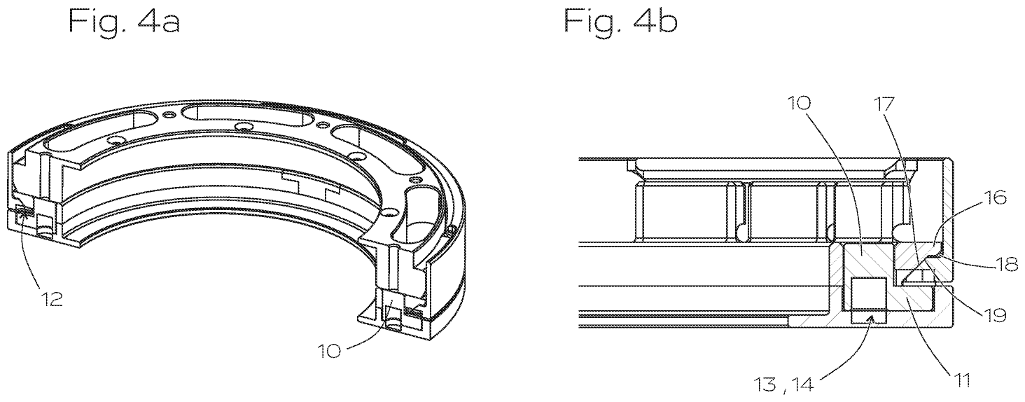

FIGS. 3a, 3b, 4a and 4b show schematic sectional representations of the holding device according to the invention as shown in FIG. 1, in which the interchangeable ring according to the invention as shown in FIG. 2 is inserted,

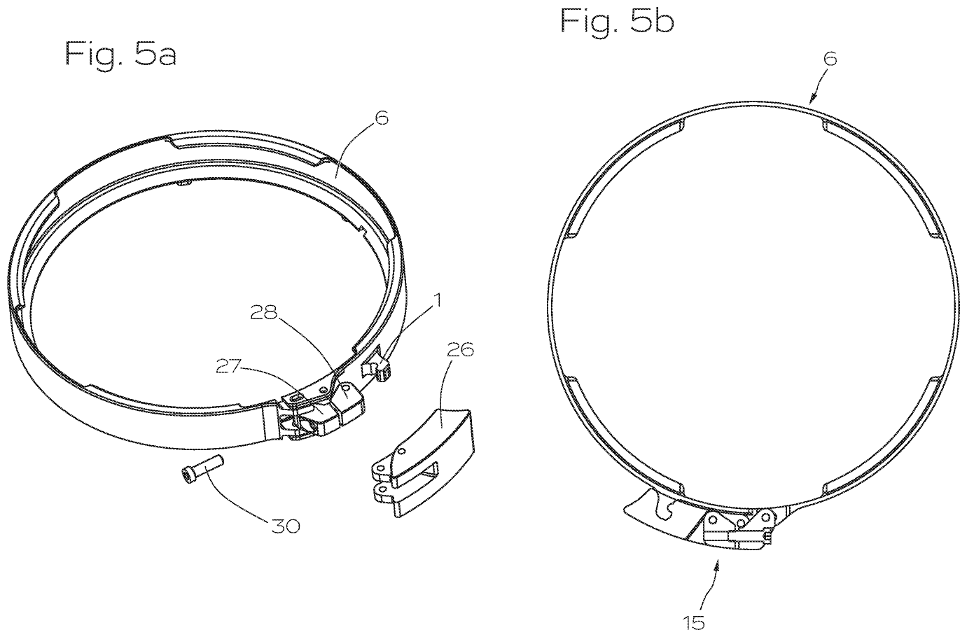

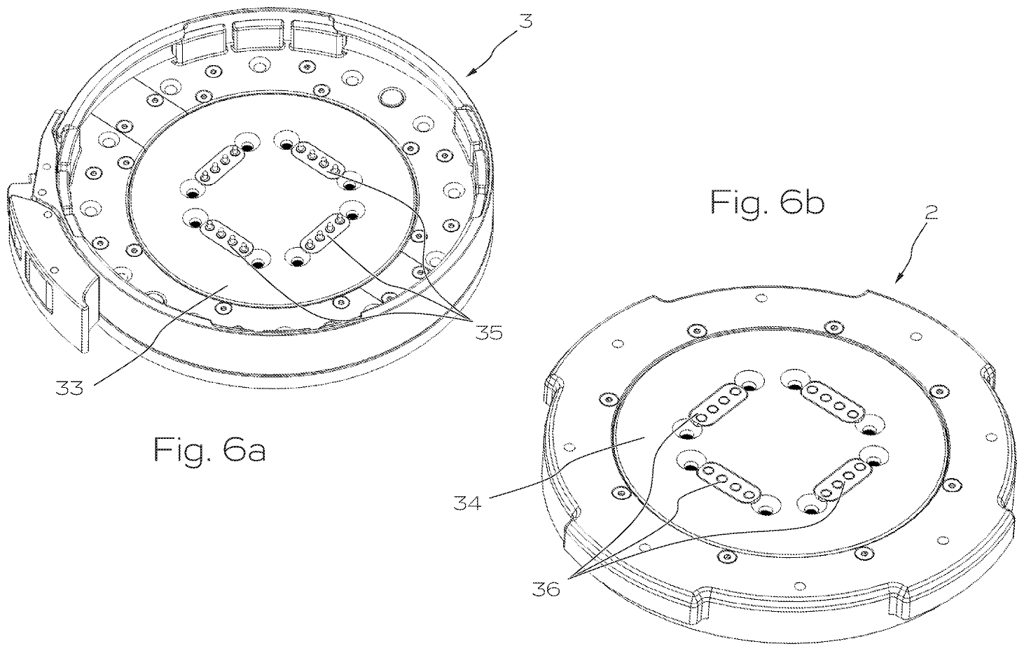

FIGS. 5a and 5b show schematic representations of a first embodiment of the sleeve ring according to the invention, and

FIGS. 6a and 6b show schematic graphical representations of a further embodiment of the holding device according to the invention and an interchangeable ring.

FIG. 1 shows a schematic graphic three-dimensional representation of the holding device 3 according to the invention for positively receiving and holding the interchangeable ring 2 according to the invention as shown in FIG. 2.

According to this embodiment, the carrier ring 5 is formed from a base plate 24 and a base part 25, which are bolted together. Optionally, the parts of the carrier ring 5 that cannot be moved relative to each other may be manufactured as one part. In the depicted embodiment, several separations are provided to enable assembly.

Twelve adjusting pins 7 are provided on the base part 25 of the carrier ring 5, projecting in the axial direction on the front face. This forms four attachment regions 22 on the carrier ring 5, wherein the respective attachment regions 22 enclose an angle 23 of 45° with one another.

Further, four holding cams 4 projecting radially outwards on the circumference are arranged on the interchangeable ring 2.

When the interchangeable ring 2 is now inserted into the carrier ring 5, the holding cams 4 are arranged in the insertion regions 31, which are located between the adjusting pins 7.

According to this embodiment, the carrier ring 5 is surrounded by a sleeve ring 6 arranged concentrically to the carrier ring 5. The sleeve ring 6 is positively and rotatably connected to the carrier ring 5. Further, the sleeve ring 6 has four clamping jaws 8 projecting radially inwards on the front face.

The sleeve ring 6 may have two positions relative to the carrier ring 5.

In the first position of the sleeve ring 6, the clamping jaws 8 are arranged in the circumferential direction next to the insertion regions 31 of the carrier ring 5. As a result, the interchangeable ring 2 can be removed from the holding device 3 and/or inserted into the holding device 3 without hindrance.

In the second position of the sleeve ring 6, the clamping jaws 8 are arranged in the circumferential direction at least in sections above the insertion regions 31 of the carrier ring 5. If the interchangeable ring 2 is inserted into the holding device 3, a positive connection is established between the interchangeable ring 2 and the holding device 3 in the second position.

According to this embodiment, the sleeve ring 6 is designed with slots and comprises a clamping device 15. A clamping force may be applied to the sleeve ring 6 by the clamping device 15, whereby the sleeve ring 6 is compressed and/or contracted.

The sleeve ring 6 may be slotted in a way that on the one hand a compression of the sleeve ring 6 and on the other hand an extension of the sleeve ring 6 is only possible up to a certain position, the so-called neutral position. This can ensure that in the event of failure of the clamping device 15, the positive connection of the holding device 3 with the interchangeable ring 2 is still present and/or given.

The design of the carrier ring 5 and the sleeve ring 6 makes it possible to create a positive and frictional connection between the interchangeable ring 2 and the holding device 3.

According to this embodiment, a first projection 16 with a first, in particular conical, sliding surface 17 is provided on the outer circumference of the carrier ring 5, in particular on the outer circumference of the base part 25, and a second projection 18 with a second, in particular conical, sliding surface 19 is provided on the inner circumference of the sleeve ring 6. Further, the adjusting pins 7 have a recess 20 for forming a weakened bending region.

The first sliding surface 17 and the second sliding surface 19 are designed to interact with each other. The tensioning of the clamping device 15 causes the second sliding surface 19 to move along the first sliding surface 17, allowing the clamping jaws 8 to move in the direction of the carrier ring 5 and in the direction of the centre of the carrier ring 5. As a result, the clamping jaws 8 may be pressed against the holding cams 4 on the one hand and the sleeve forming the sleeve ring 6 and the adjusting pins 7 may be pressed against the interchangeable ring 2 on the other hand.

This may create a substantially rigid connection between the interchangeable ring 2 and the holding device 3.

According to this embodiment, two fixation devices 9 are provided for fixing the sleeve ring 6 in its first position, each comprising a fixation pin 10 with a fixation projection 11.

The respective fixation device 9 may substantially assume two positions. In the first position of the fixation device 9, the fixation projection 11 engages positively in a recess 12 of the sleeve ring 6, whereby the sleeve ring 6 is held in its first position.

In the second position of the fixation device 9, the fixation projection 11 is arranged at a distance from the sleeve ring 6, so that the sleeve ring 6 is rotatable relative to the carrier ring 5.

According to this embodiment, a spring 14 is arranged in a recess 13 of the carrier ring 5, wherein the spring 14 is configured to bring the respective fixation device 9 into its first position. In the first position of the fixation device 9, the fixation pin 10 projects from the carrier ring 5. By inserting the interchangeable ring 2 into the holding device 3, the fixation pins 10 and thus also the springs 14 are compressed, bringing the fixation devices 9 into their second position. In other words, the sleeve ring 6 is freely rotatable relative to the carrier ring 5 as soon as the interchangeable ring 2 is inserted into the holding device 3.

According to this embodiment, the holding device 3 comprises a rotation device 21 comprising a spring 14, which is arranged in an annular groove of the carrier ring 5. The rotation device 21 is configured to bring the sleeve ring 6 into its second position.

The spring 14 is in engagement with the sleeve ring 6 and the carrier ring 5. In the first position of the rotation device 21, the spring 14 generates a spring force F1 acting on the sleeve ring 6, whereby the sleeve ring 6 can be brought into its first position. In the second position of the rotation device 21, in which the sleeve ring 6 is in its second position, the spring 14 generates a spring force F2 acting on the sleeve ring 6. This spring force F2 is less than the spring force F1. In other words, the spring 14 is partially released when the sleeve ring 6 is in its second position.

According to this embodiment, a connection between the interchangeable ring 2 and the carrier ring 5 is established according to the following steps. First, the sleeve ring 6 is brought into its first position, in which the clamping jaws 8 are arranged next to the insertion regions 31. In this position, the fixation projection 11 of the fixation device 9 engages in a recess 12 of the sleeve ring 6, whereby the sleeve ring 6 is fixed in its first position. When the interchangeable ring 2 is inserted, the fixation pins 10 projecting beyond the carrier ring 5 are pressed downwards. As a result, the fixation devices 9 and the fixation projections 11 arranged on them are also moved downwards and the sleeve ring 6 is released. The spring force acting on the sleeve ring 6, generated by the rotation device 21, brings the sleeve ring 6 into its second position immediately after its release. In the second position, the clamping jaws 8 are arranged at least partially over the insertion regions 31, whereby the interchangeable ring 2 is positively engaged with the holding device 3. In this second position of the sleeve ring 6, the interchangeable ring 2 is already positively connected to the holding device 3, which means that unintentional separation can no longer occur.

This means that only one person is required to create the connection between the interchangeable ring 2 and the holding device 3, as the substantial changes in position of the individual components take place automatically.

The sleeve ring 6 may then be compressed by actuating the clamping device 15. Among other things, this moves the clamping jaws 8 towards the carrier ring 5 and towards the centre of the carrier ring 5 and presses the adjusting pins 7 towards the centre of the carrier ring 5. This may produce a frictional and positive connection between the holding device 3 and the interchangeable ring 2.

According to this embodiment, the clamping device 15 has a clamping lever 26, a first clamping part 27, a second clamping part 28, three connection devices 29 and an adjusting device 30. The connection devices 29 are not depicted for better clarity.

The first clamping part 27 is connected to the sleeve ring 6 via the first connection device 29. The clamping lever 26 is connected to the sleeve ring 6 via the second connection device 29. The second clamping part 28 is connected to the clamping lever 26 via the third connection device 29. According to this embodiment, the first and second clamping parts 27, 28 are connected to each other via the adjusting device 30, whereby the clearance between the two clamping parts 27, 28 can be changed and the clamping force of the clamping device 15 can be adjusted by actuating, in particular rotating, the adjusting device 30.

According to this embodiment, a securing device 1 is provided on the sleeve ring 6. The securing device 1 is designed to hold, fix and/or secure the clamping lever 26 in its tensioned and/or closed settings, in particular its holding setting.

The clamping lever 26 has a blocking device, wherein the blocking device may engage in a recess 32 of the carrier ring 5, in particular a recess 32 of the base plate 24, when the sleeve ring 6 is in its second position.

FIGS. 6a and 6b show schematic graphic representations of a further embodiment of the holding device 3 according to the invention and an interchangeable ring 2 for insertion into this holding device 3. In this embodiment, there is a first contact device 33 in the holding device 3 and a second contact device 34 in the interchangeable ring 2, each in the form of a circular insert. The contact devices 33, 34 have electrical contacts 35, 36 in the form of electrical plug pins and correspondingly designed sockets. The electrical contacts are formed in four orthogonally arranged rows of 4 contacts each.

This allows an electrical or electronic connection to be created between the first contact device 33 and the second contact device 34 when the interchangeable ring 2 is inserted into the holding device 3.

This configuration may be provided in all embodiments.

This exemplary configuration allows the inventive effects to be achieved.

The invention is not limited to the illustrated embodiments, but includes any holding device 3, any interchangeable ring 2, any arrangement comprising the holding device 3 according to the invention, and any method according to the following claims.

### LIST OF REFERENCE NUMBERS

1 Securing device
2 Interchangeable ring
3 Holding device
4 Holding cams
5 Carrier ring
6 Sleeve ring
7 Adjusting pin
8 Clamping jaw
9 Fixation device
10 Fixation pin
11 Fixation projection
12 Recess (in the sleeve ring)
13 Recess (in the carrier ring)
14 Spring
15 Clamping device
16 First projection
17 First sliding surface
18 Second projection
19 Second sliding surface
20 Recess (in the adjusting pin)
21 Rotation device
22 Attachment region
23 Angle
24 Base plate
25 Base part
26 Clamping lever
27 First clamping part
28 Second clamping part
29 Connection device
30 Adjusting device
31 Insertion region
32 Recess
33, 34 Contact devices
35,36 Electrical contacts

1. A holding device (3) for positively receiving and holding an interchangeable ring (2) with holding cams (4) projecting radially outwards on the circumferential side, wherein the holding device (3) comprises a carrier ring (5) having a plurality of adjusting pins (7) projecting in the axial direction and between which at least one insertion region (31) for receiving at least one part of the interchangeable ring (2), in particular of the holding cams (4) of the interchangeable ring (2), is recessed, characterized
in that a sleeve ring (6) positioned concentrically with respect to the carrier ring (5) is provided outside the carrier ring (5) and is rotatably and in particular positively connected to the carrier ring (5),
in that the sleeve ring (6) has at least one radially inwardly protruding clamping jaw (8),
in that, in a first position of the sleeve ring (6) relative to the carrier ring (5), the clamping jaw (8) is positioned adjacent to the insertion region (31) of the carrier ring (5), in particular in the peripheral direction,
and in that, in a second position of the sleeve ring (6) relative to the carrier ring (5), the clamping jaw (8) is positioned at least partially above the insertion region (31) of the carrier ring (5), in particular in the peripheral direction.

2. The holding device (3) according to claim 1, characterized
in that the sleeve ring (6) is designed with slots,
and/or in that a clamping device (15) is provided on the sleeve ring (6) for compressing the sleeve ring (6), allowing the sleeve ring (6) to be non-positively connected to the carrier ring (5).

3. The holding device (3) according to claim 1, characterized
in that the carrier ring (5), in particular the outer circumference of the carrier ring (5), has a first projection (16) with a first, in particular conical, sliding surface (17),
in that the sleeve ring (6), in particular the inner circumference of the sleeve ring (6), has a second projection (18) having a second, in particular conical, sliding surface (19),
and in that the first sliding surface (17) and the second sliding surface (19) are designed to interact, so that when the clamping device (15) is tensioned, the second sliding surface (19) can be moved along the first sliding surface (17), enabling the holding cams (4) of the interchangeable ring (2) to be pressed against the clamping jaws (8) of the sleeve ring (6).

4. The holding device (3) according to claim 1, characterized
in that the adjusting pins (7) have at least one recess (20) for forming a weakened bending region,
and/or that the adjusting pins (7) can be pressed towards the center of the carrier ring (5) when the sleeve ring (6) is tensioned by means of the clamping device (15).

5. The holding device (3) according to claim 1, characterized in that at least one fixation device (9) is provided for holding the sleeve ring (6) in the first position.

6. The holding device (3) according to claim 5, characterized
in that the fixation device (9) has a fixation pin (10) having a fixation projection (11),
in that the fixation projection (11) positively engages in a recess (12) of the sleeve ring (6) in a first position of the fixation device (9), thus holding the sleeve ring (6) in its first position,
and in that the fixation projection (11) releases the sleeve ring (6) in a second position of the fixation device (9), so that the sleeve ring (6) is rotatable relative to the carrier ring (5).

7. The holding device (3) according to claim 6, characterized
in that the fixation device (9), in particular the fixation pin (10), is arranged in a recess (13), in particular a bore, in the carrier ring (5),
in that a spring (14) is provided which presses the fixation device (9) into its first position,
and in that the spring (14) can be compressed by inserting the interchangeable ring (2) into the holding device (3) to bring the fixation device (9) into its second position.

8. The holding device (3) according to claim 1, characterized in that a rotation device (21) is provided, which is configured to bring the sleeve ring (6) into its second position.

9. The holding device (3) according to claim 8, characterized
in that the rotation device (21) comprises between one spring (14) up to and including ten springs (14), preferably two springs (14), which is in engagement with the sleeve ring (6) and the carrier ring (5),
in that the rotation device (21) has a first position in which the sleeve ring (6) is in its first position and in which the spring (14) generates a spring force F1, as a result of which the sleeve ring (6) can be brought into its second position,
and in that the rotation device (21) has a second position in which the sleeve ring (6) is in its second position and in which the spring (14) generates a spring force F2, wherein the spring force F2 is smaller than the spring force F1.

10. The holding device (3) according to claim 1, characterized
in that the holding device (3) has one insertion region (31) or between two and including ten, preferably four, insertion regions (31),
and/or that the insertion regions (31) are in particular evenly radially distributed on the holding device (3),
and/or in that the respective insertion regions (31) arranged one after the other enclose an angle (23) with one another in the range from 18° to including 90°, in particular 45°.

11. The holding device (3) according to claim 1, characterized
in that the clamping device (15) comprises a clamping lever (26), a first clamping part (27), a second clamping part (28), three connection devices (29) and an adjusting device (30),
in that the first clamping part (27) is connected to the sleeve ring (6) via the first connection device (29),
in that the clamping lever (26) is connected to the sleeve ring (6) via the second connection device (29),
in that the second clamping part (28) is connected to the clamping lever (26) via the third connection device (29),
and in that the first and second clamping parts (27, 28) are connected to one another via the adjusting device (30), allowing the clearance between the two clamping parts (27, 28) to be changed and the clamping force of the clamping device (15) to be adjusted by actuating the adjusting device (30).

12. The holding device (3) according to claim 1, characterized
in that a securing device (1) is provided on the sleeve ring (6),
and in that the securing device (1) is designed to hold the clamping lever (26) in its clamped and/or closed position.

13. The holding device (3) according to any one of claim 1, characterized in that a first contact device (33) with first electrical contacts (35) is provided within the holding device (3), which is preferably designed to establish an electrical or electronic connection to a second contact device (34) with second electrical contacts (36) arranged within the interchangeable ring (2).

14. An interchangeable ring (2), characterized in that the interchangeable ring (2) is arranged for introduction and/or insertion into the holding device (3) according to claim 1.

15. An arrangement comprising a holding device (3) according to claim 1 and an interchangeable ring (2), wherein the holding device (3) is optionally connected to a vehicle, in particular an aircraft, preferably a camera drone, or a device, such as in particular a handle, a crane, a camera crane, a camera dolly, a tripod, a Steadicam and/or a slider, and the interchangeable ring (2) is connected to a camera device.

16. A method for attaching an interchangeable ring (2) to a holding device (3) according to claim 1, comprising the following steps:
bringing the sleeve ring (6) into its first position, in which the at least one clamping jaw (8) is arranged next to the at least one insertion region (31),
inserting the interchangeable ring (2),
bringing the sleeve ring (6) into its second position, in which the at least one clamping jaw (8) is arranged at least in sections over the insertion region (31) and thus over the holding cams (4) of the interchangeable ring (2), so that the interchangeable ring (2) is positively engaged with the holding device (3).

17. The method according to claim 16, comprising the following further steps:
actuation and/or tensioning of the clamping device (15), whereby the sleeve ring (6) is tensioned and both the clamping jaws (8) are moved towards the carrier ring (5) and towards the center of the carrier ring (5), and the adjusting pins (7) are pressed towards the center of the carrier ring (5), so that the holding cam(s) (4) of the interchangeable ring (2) is/are frictionally and positively engaged with the holding device (3),
optionally, bringing the clamping device (15), in particular the clamping lever (26), into its holding setting, so that in particular the hook of a further lever device is engaged in a groove and/or the clamping lever (26) is fixed to the securing device (1).

18. A method for removing the interchangeable ring (2) from the holding device (3) according to claim 1, comprising the following steps:
optionally, bringing the clamping device (15), in particular the clamping lever (26), from its holding position to its release position, so that in particular the hook of the additional lever device is removed from the groove and/or moved and/or the clamping lever (26) is released from the securing device (1),
opening and/or releasing the clamping device (15),
rotating the interchangeable ring (2) so that the sleeve ring (6) is brought into its first position, in which the at least one clamping jaw (8) is or are arranged next to the at least one insertion region (31),
removing the interchangeable ring (2) from the holding device (3).
